(19) United States
(12) Patent Application Publication
(10) Pub. No.: US 2015/0195360 A1
(43) Pub. Date: Jul. 9, 2015

(54) STREAMING SYSTEM AND NODE DEVICE USED IN STREAMING SYSTEM

(71) Applicant: FUJITSU LIMITED, Kawasaki-shi (JP)

(72) Inventor: Miwa SHIMADA, Kawasaki (JP)

(21) Appl. No.: 14/542,759

(22) Filed: Nov. 17, 2014

(30) Foreign Application Priority Data
Jan. 9, 2014 (JP) 2014-002312

(51) Int. Cl. H04L 29/08; H04L 29/06

(52) U.S. Cl. CPC H04L 67/14; H04L 65/60

(57) ABSTRACT

A streaming system provides a streaming service to a node device. The streaming system includes: a newly-joined node device configured to newly join the streaming service and transmit a join request to a node device within a specified range; and a node device configured to receive the join request and return a join response corresponding to the join request to the newly-joined node device when the node device that receives the join request is capable of providing the streaming service. The newly-joined node device transmits a delivery request to a node device that first returns the join response corresponding to the join request.

### CROSS-REFERENCE TO RELATED APPLICATION

This application is based upon and claims the benefit of priority of the prior Japanese Patent Application No. 2014-002312, filed on Jan. 9, 2014, the entire contents of which are incorporated herein by reference.

### FIELD

The embodiments discussed herein are related to a streaming system and a node device used in the streaming system.

### BACKGROUND

Streaming delivery (or streaming) has spread as a method of delivering image data. Streaming delivery allows terminal devices to play an image while downloading the image data file. Because of this, streaming delivery can realize live delivery. Also, even when the size of an image data file is large, terminal devices can play the image without large-capacity storage.

P2P (peer to peer) communication has been implemented in practical use as a communication scheme for providing streaming delivery. In P2P communication, a plurality of terminal devices are treated equally when they conduct communications. In other words, each terminal device can operate as a receiver which receives data, and can also operate as a transmitter which transmits (or forwards) data to other devices. Because of this, P2P communication can provide a flexible network.

A streaming system for providing streaming delivery that utilizes P2P has a root node device. A root node device manages joined node devices, which receive streaming data provided by the streaming service. When a new node device (referred to as a newly-joined node device) is to receive the streaming service, that newly-joined node device transmits a join request to the root node device. The root node device provides candidate parent node information to the newly-joined node device. Then, the newly-joined node device selects a parent node device using the candidate parent node information and receives streaming data from that parent node device.

Note that, as a related art, a server system and a client device have been proposed that realize stable communications in a relay scheme for P2P. Also, a method has been proposed for reliably performing a large-scale streaming delivery with P2P (For example, Japanese Laid-open Patent Publication No. 2011-151701 and International Publication Pamphlet No. WO2010/067457).

As described above, a newly-joined node device transmits a join request to the root node device in order to receive a streaming service. Thus, when for example there are many newly-joined node devices, the response from the root node device becomes poor. This forces newly-joined node devices to wait for a longer period of time before starting the reception of the streaming service. In other words, user convenience deteriorates in some cases.

### SUMMARY

According to an aspect of the embodiments, a streaming system provides a streaming service to a node device. The streaming system includes a newly-joined node device configured to newly join the streaming service and transmit a join request to a node device within a specified range; and a node device configured to receive the join request and return a join response corresponding to the join request to the newly-joined node device when the node device that receives the join request is capable of providing the streaming service. The newly-joined node device transmits a delivery request to a node device that first returns the join response corresponding to the join request.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIGS. 1-5 illustrate an outline of operations of a video streaming system;

FIG. 6 is a block diagram illustrating functions of a root node device;

FIG. 7 is a block diagram illustrating functions of a node device;

FIG. 8 is a flowchart illustrating operations of a newly-joined node device;

FIG. 9 is a flowchart illustrating operations of a joined node device;

FIG. 10 is a sequence diagram for a case when a joined node device that can deliver streaming data exists close to a newly-joined node device;

FIG. 11 is sequence diagram for a case when no joined node devices that can deliver streaming data exist close to a newly-joined node device;

FIG. 12 explains a method of deciding whether or not to respond to a join request based on operation states of anode device;

FIG. 13A and FIG. 13B explain a method of deciding whether or not to respond to a join request based on a delivery tree; and

FIG. 14 illustrates an example of a hardware configuration of a node device according to the embodiment of the present invention.

### DESCRIPTION OF EMBODIMENTS

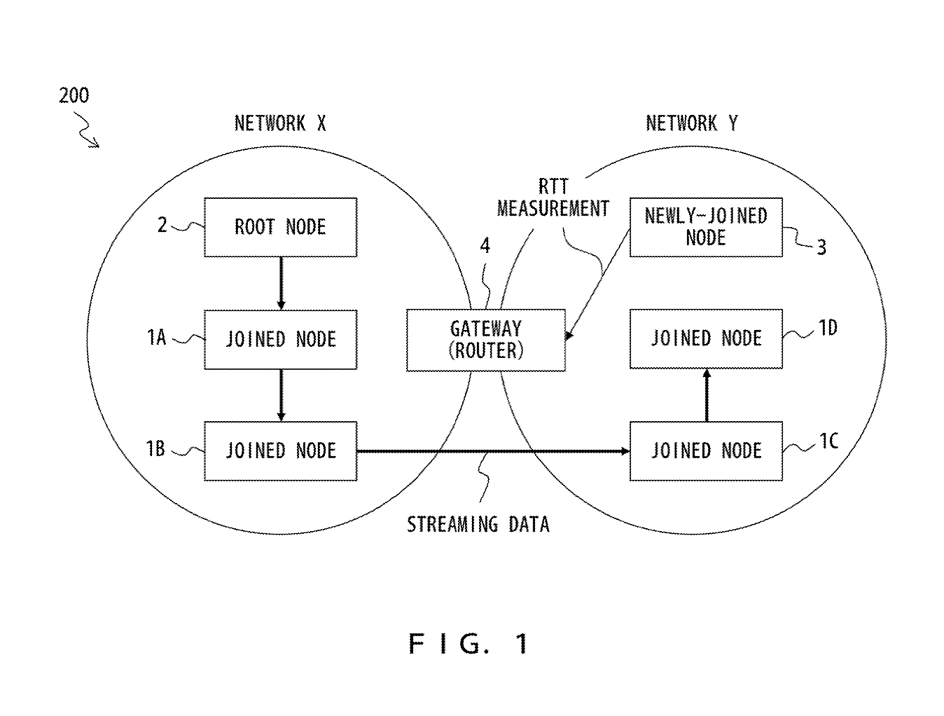

FIGS. 1-5 illustrate an outline of operations of a video streaming system 200 according to an embodiment of the present invention. The video streaming system 200 can provide a streaming service in response to a request from a user.

The video streaming system 200 includes a plurality of node devices. Each node device can join a streaming service provided by the video streaming system 200. In this example, node devices 1A, 1B, 1C and 1D have joined the streaming service as illustrated in FIG. 1. In other words, node devices 1A, 1B, 1C and 1D are respectively receiving streaming data. In the description below, a node device that has joined a streaming service may be referred to as “joined node device (or joined node)”.

The video streaming system 200 also includes a root node device 2. The root node device 2 manages states of streaming delivery. For example, the root node device 2 manages a delivery tree that represents connection states of joined node devices. In other words, the root node device 2 manages routes used for delivering streaming data to respective joined node devices. The root node device 2 is located in the most upstream stage in the streaming delivery in this example. The root node device 2 obtains image data from a content server and performs streaming delivery to joined node devices. Note that a content server may operate as a root node device.

Each node device has a function of realizing P2P communication. Streaming data transmitted from the root node device 2 is delivered to respective joined nodes via one or a plurality of joined node devices. In the example illustrated in FIG. 1, the root node device 2 transmits streaming data to joined node device 1A. Joined node device 1A forwards the streaming data to joined node device 1B. Similarly, joined node device 1B forwards the streaming data to joined node device 1C, and joined node device 1C forwards the streaming data to joined node device 1D. Through this streaming, joined node devices 1A-1D can roughly simultaneously receive the image data transmitted from the root node device 2.

Each node device is accommodated in a router. In this example, a plurality of node devices accommodated in each router form a network. For example, joined node devices 1A and 1B and the root node device 2 belong to network X, while joined node devices 1C and 1D belong to network Y, as illustrated in FIG. 1. In each of the networks X and Y, the distance between node devices is one hop. Note that networks X an Y are connected to each other via a gateway 4.

In the video streaming system 200, it is assumed that a node device 3, which belongs to network Y, will newly join the streaming service. In the description below, a node device that newly joins a streaming service may be referred to as a “newly-joined node device (or newly-joined node)”.

The newly-joined node device 3 first measures the Round Trip Time (RTT) with respect to a router that accommodates the newly-joined node device 3. In other words, the newly-joined node device 3 measures the RTT with respect to the gateway 4 as illustrated in FIG. 1. The RTT is measured by for example transmitting Ping from the newly-joined node device 3 to the gateway 4. However, RTTs may be measured by a different method.

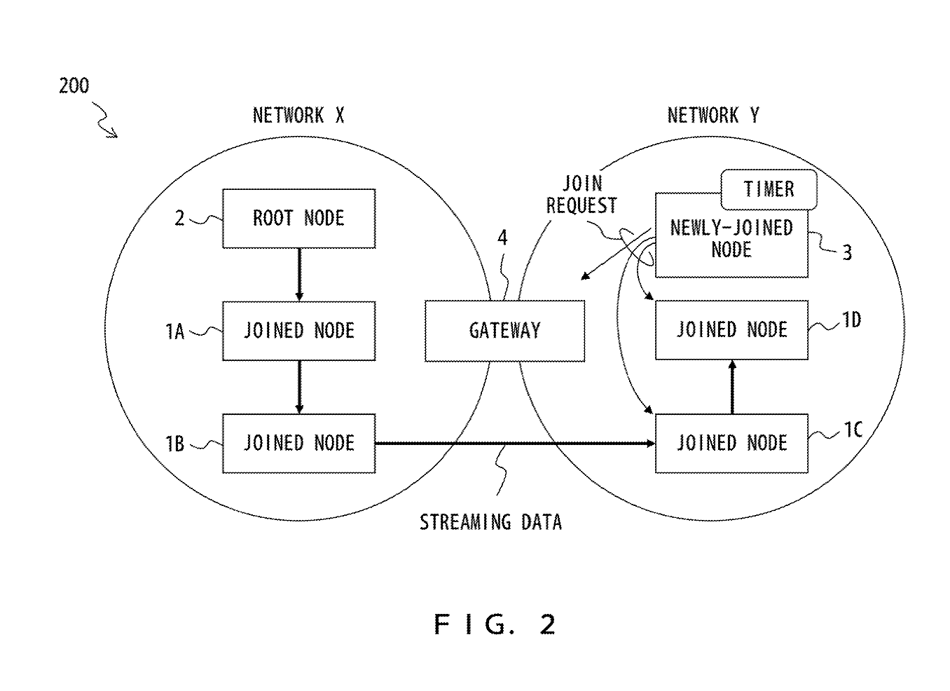

Next, the newly-joined node device 3 transmits a multicast join request to all nodes belonging to network Y as illustrated in FIG. 2. For example, the multicast join request is stored in a multicast packet to which a multicast address used in network Y is added. Also, “Time To Live (TTL)=1” is added to this multicast join request. TTL is decremented by one by a gateway (router) that receives the packet in a packet forwarding process. When the TTL added to the packet has become zero, that packet is not forwarded thereafter. Accordingly, a multicast join request in which TTL=1 is set is received by a node device located within a range of one hop from the newly-joined node device 3. In other words, a multicast join request transmitted from the newly-joined node device 3 is received by each node device (joined node devices 1C and 1D in FIG. 2) in network Y.

This multicast join request is received also by the gateway 4. However, the TTL of the multicast join request is updated from one to zero in the gateway 4. Accordingly, the multicast join request is not forwarded to network X.

When transmitting the multicast join request described above, the newly-joined node device 3 activates a timer. This timer measures the RTT between the newly-joined node device 3 and the gateway 4. Note that the newly-joined node device 3 has previously measured the RTT in FIG. 1. Then the newly-joined node device 3 waits for a join response corresponding to the multicast join request up to the time when the timer expires.

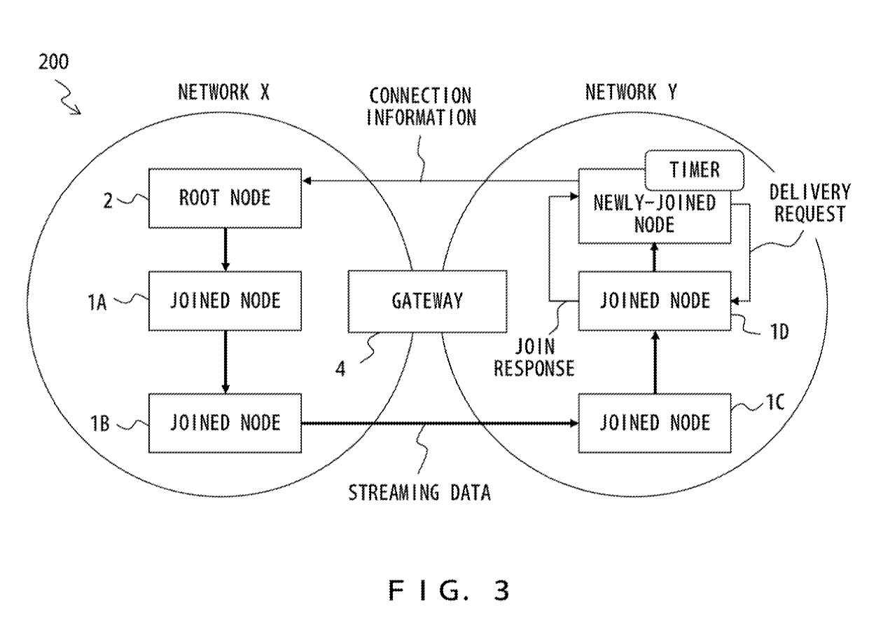

Joined node devices that have received the multicast join request respectively decide whether or not to respond to that join request. A joined node device that can deliver streaming data to a newly-joined node device responds to the received join request. In such a case, the joined node device that has received the join request returns a join response to the newly-joined node device 3. In the example illustrated in FIG. 3, joined node devices 1C and 1D have received the multicast join request from the newly-joined node device 3 and joined node device 1D returns a join response to the newly-joined node device 3. A joined node device that is not able to deliver streaming data to the newly-joined node device discards the received join request. A node device that has not joined the streaming service also discards a received join request.

It is assumed that the newly-joined node device 3 receives a join response from joined node device 1D before the timer expires. This timer measures the RTT between the newly-joined node device 3 and the gateway 4 as described above. Accordingly, when the newly-joined node device 3 receives a join response before the timer expires, the newly-joined node device 3 decides that a joined node device that can deliver streaming data exists at a closer location than the gateway 4. In such a case, the newly-joined node device 3 identifies a joined node device that returned the join response and transmits a delivery request to the identified joined node device. In the example illustrated in FIG. 3, the newly-joined node device 3 transmits a delivery request to joined node device 1D. In this situation, joined node device 1D starts streaming delivery to the newly-joined node device 3 in response to the delivery request.

When the newly-joined node device 3 receives a plurality of join responses before the timer expires, the newly-joined node device 3 transmits a delivery request to the joined node device that first returned a join response. In such a case, the newly-joined node device 3 may receive streaming data from the joined node device existing closest to the newly-joined node device 3.

As described above, the newly-joined node device 3 can receive streaming data from a joined node device existing close to the newly-joined node device 3 without accessing the root node device 2. Accordingly, this method avoids or suppresses the deterioration in the response caused by congestion at a root device even when many node devices simultaneously request a streaming service.

Thereafter, the newly-joined node device 3 transmits connection information to the root node device 2. Connection information includes information for identifying a source node device of streaming data. In this example, the connection information includes information for identifying node device 1D. Note that a source node device of streaming data may be referred to as a “parent node device (or a parent node)” in some cases. For example, the parent node device of the newly-joined node device 3 is joined node device 1D, and the parent node device of joined node device 1D is joined node device 1C.

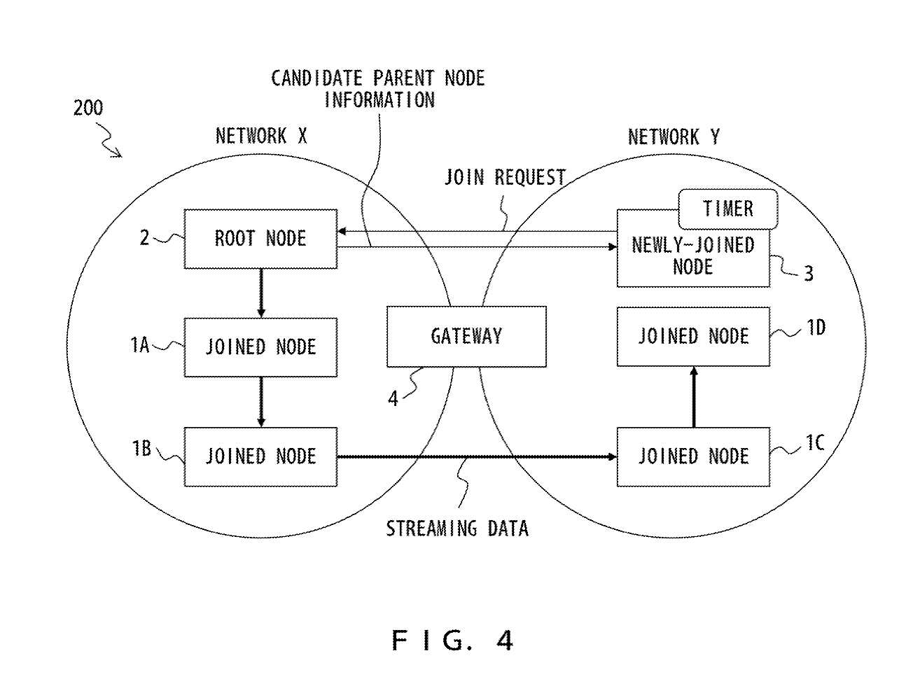

In the example illustrated in FIG. 2 and FIG. 3, the newly-joined node device 3 receives a join response from a joined node device before the timer expires. By contrast, FIG. 4 illustrates a situation where the newly-joined node device 3 failed to receive a join response before the expiration of the timer.

When the newly-joined node device 3 failed to receive a join response before the expiration of the timer, the newly-joined node device 3 decides that a joined node device that can deliver streaming data does not exist close to the newly-joined node device 3. In such a case, the newly-joined node device 3 transmits a unicast join request to the root node device 2 as illustrated in FIG. 4.

Upon receiving the join request, the root node device 2 generates candidate parent node information and transmits the information to the newly-joined node device 3. The candidate parent node information includes a list of joined node devices that can operate as a parent node device for the newly-joined node device 3. In other words, the candidate parent node information includes a list of joined node devices that can deliver streaming data to the newly-joined node device 3. The newly-joined node device 3 selects one joined node device from among the joined node devices listed in the candidate parent node information, and transmits a delivery request to the selected joined node device. Thereby, the newly-joined node device 3 can receive streaming data from the selected joined node device.

As described above, the newly-joined node device 3 transmits a join request to the root node device 2 so as to obtain candidate parent node information. However, the newly-joined node device 3 transmits a join request to the root node device 2 only when the newly-joined node device 3 does not receive a join response within a prescribed period of time. Accordingly, the congestion at the root node device 2 caused by join requests from newly-joined node devices is suppressed.

Each joined node device decides in advance whether or not to respond to join requests received from a newly-joined node device. This decision is based on whether or not it is possible to deliver streaming data to a newly-joined node device.

For example, when the hardware resources (the CPU, a memory, etc.) of a node device have a sufficiently high performance, that node device decides to respond to the join request. However, when the usage rate of the hardware resources of a node device is high, that node device decides not to respond to the join request.

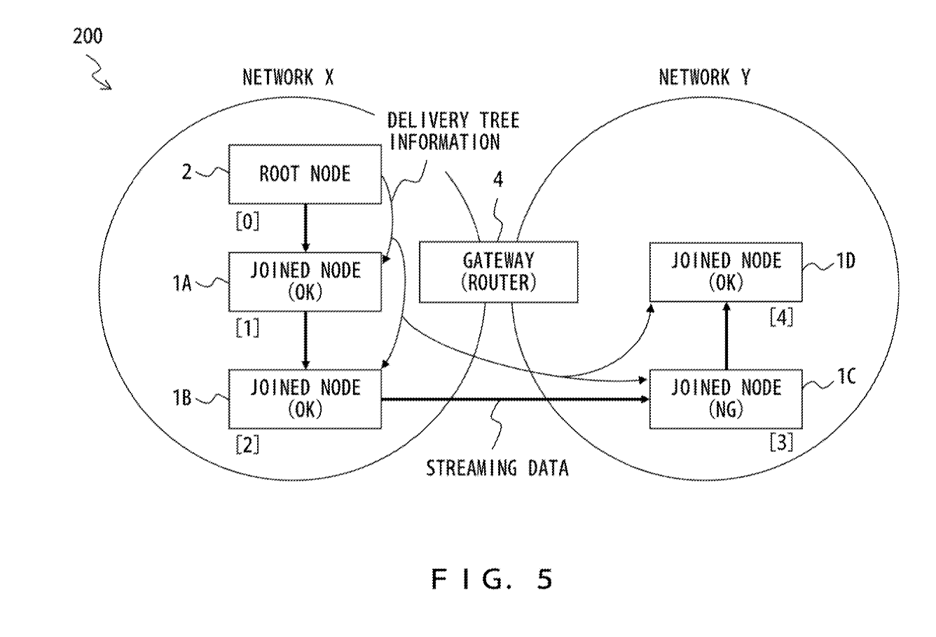

A joined node device may make the decision based on the configuration of the delivery tree. When, for example, a large number of joined node devices exist between the root node device 2 and a node device, that node device decides not to respond to the join request. Note that the delivery tree information, that represents the configuration of the delivery tree, is transmitted from the root node device 2 to each joined node device as illustrated in FIG. 5. When for example the configuration of the delivery tree has changed, the root node device 2 transmits the updated delivery tree information to each joined node device. The root node device 2 may transmit the delivery tree information periodically to each joined node device.

The header of streaming data delivered from the root node device 2 stores relay count data, which is for counting the number of relay nodes. When streaming data is transmitted from the root node device 2, the relay count data is zero. The relay count data is incremented by one each time the streaming data is relayed by a joined node device. In other words, the relay count data stored in the header of streaming data is incremented to one, two, three and four at joined node devices 1A, 1B, 1C and 1D, respectively, as illustrated in FIG. 5. Each joined node device may use the relay count data to decide whether or not to respond to a join request. For example, a joined node device decides not to respond to a join request when the number of relays is greater than a specified threshold.

As described above, each joined node device decides in advance whether or not to respond to a join request. Also, each joined node device updates a decision result, that represents whether or not to respond to join requests, in accordance with its own operation states, changes in the configuration of the delivery tree, and other factors. In the example illustrated in FIG. 5, joined node devices 1A, 1B and 1D are in a state in which they will respond to the join request (“OK” in FIG. 5). By contrast, joined node device 1C is in a state in which it will not respond to the join request (“NG” in FIG. 5).

In such a case, when joined node devices 1A, 1B and 1D receive a join request from a newly-joined node device, they return corresponding join response. On the other hand, joined node device 1C does not return a join response when it receives a join request from a newly-joined node device. Note that, in the example illustrated in FIG. 2, a multicast join request transmitted from the newly-joined node device 3 does not reach joined node device 1A or 1B. Accordingly, only joined node device 1D returns a join response to the newly-joined node device 3 in this example.

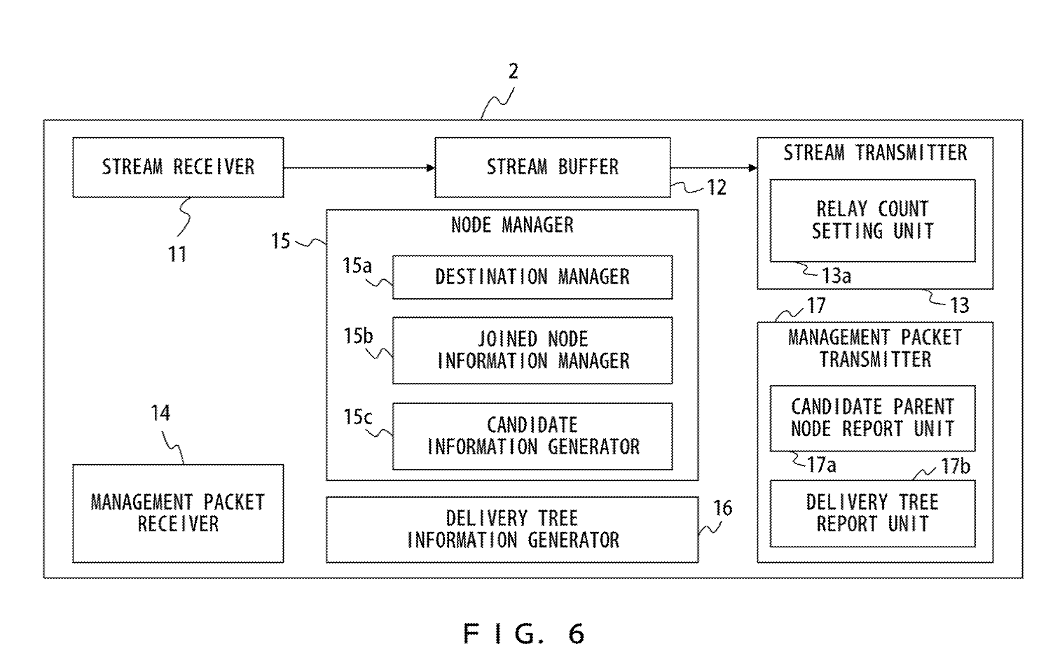

FIG. 6 is a block diagram illustrating functions of the root node device 2. As illustrated in FIG. 6, the root node device 2 includes a stream receiver 11, a stream buffer 12, a stream transmitter 13, a management packet receiver 14, a node manager 15, a delivery tree information generator 16, and a management packet transmitter 17. The root node device 2 may have additional functions that are not illustrated in FIG. 6. The functions illustrated in FIG. 6 may be realized by executing a program using a computer.

The stream receiver 11 receives or obtains streaming data corresponding to the content requested by a user from a content server. Thereafter, the stream receiver 11 stores the received or obtained streaming data in the stream buffer 12. The stream transmitter 13 reads the streaming data from the stream buffer 12 and transmits the streaming data to a joined node device. The stream transmitter 13 includes a relay count setting unit 13a. The relay count setting unit 13a provides an initial value (i.e., zero) to the relay count data stored in the header of the streaming data.

The management packet receiver 14 receives management packets from a joined node device and a newly-joined node device. For example, the management packet receiver 14 receives a management packet containing connection information from the newly-joined node device 3 in the example illustrated in FIG. 3. In the example illustrated in FIG. 4, the management packet receiver 14 receives a management packet containing a unicast join request from the newly-joined node device 3. Further, the management packet receiver 14 may receive a delivery request in some cases.

The node manager 15 includes a destination manager 15a, a joined node information manager 15b, and a candidate information generator 15c in order to manage joined node devices. The destination manager 15a stores information for identifying a destination node device of streaming data. The destination manager 15a updates stored information in accordance with for example connection information or a unicast join request received from a newly-joined node device. The joined node information manager 15b stores information related to each node device that has joined the streaming service. Information related to a node device may include for example information representing the performance of the hardware resources of a node device. The candidate information generator 15c generates candidate parent node information in response to a join request received from a newly-joined node device. The candidate information generator 15c generates candidate parent node information in cooperation with the streaming destination manager 15a and the joined node information manager 15b. For example, the candidate information generator 15c may select a node device having high-performance hardware resources from among joined node devices and registers the selected node device in the candidate parent node information.

The delivery tree information generator 16 generates delivery tree information. Delivery tree information represents connection relationships between node devices that have joined a streaming service. In other words, delivery tree information represents a delivery route of streaming data from the root node device 2 to each joined node device. The delivery tree information generator 16 generates delivery tree information by using information managed by the node manager 15. Note that the delivery tree information generator 16 updates delivery tree information when the configuration of the delivery tree has changed.

The management packet transmitter 17 transmits a management packet to joined node devices and a newly-joined node device. In the example illustrated in FIG. 4, the management packet transmitter 17 for example transmits a management packet containing candidate parent node information to the newly-joined node device 3. This management packet is generated by a candidate parent node report unit 17a. The candidate parent node report unit 17a generates a management packet containing candidate parent node information that is generated by the candidate information generator 15c. Also, in the example illustrated in FIG. 5, the management packet transmitter 17 transmits a management packet containing delivery tree information to each joined node device. This management packet is generated by a delivery tree report unit 17b. The delivery tree report unit 17b generates a management packet containing delivery tree information that is generated by the delivery tree information generator 16. The management packet transmitter 17 may also transmit a different management packet.

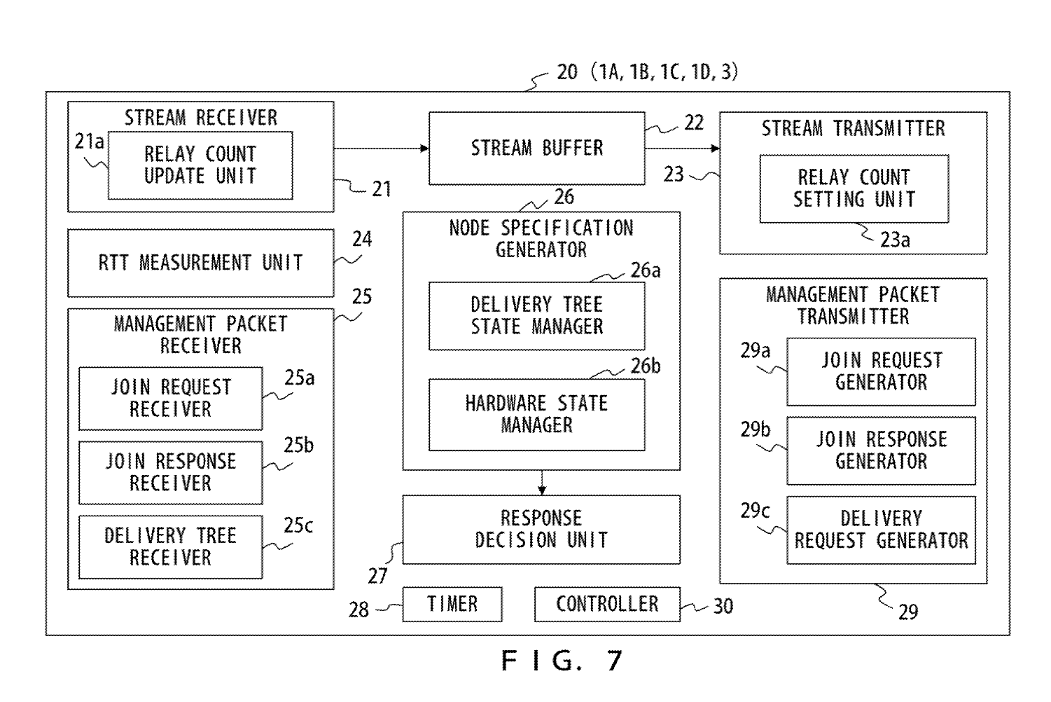

FIG. 7 is a block diagram illustrating functions of a node device. The node device 20 includes a stream receiver 21, a stream buffer 22, a stream transmitter 23, an RTT measurement unit 24, a management packet receiver 25, a node specification generator 26, a response decision unit 27, a timer 28, a management packet transmitter 29, and a controller 30, as illustrated in FIG. 7. The node device 20 may have different functions that are not illustrated in FIG. 7. Also, the node device 20 may operate as a joined node device (or a newly-joined node device). The functions illustrated in FIG. 7 may be realized by executing a program using a computer.

The stream receiver 21 receives streaming data from the root node device 2 or a joined node device on the upstream side. The stream receiver 21 includes a relay count update unit 21a. The relay count update unit 21a increments the relay count data stored in the header of received streaming data by one. Then, the stream receiver 21 stores the streaming data in the stream buffer 22. The stream transmitter 23 reads streaming data from the stream buffer 22 and transmits the streaming data to a joined node device on the downstream side. The stream transmitter 23 includes a relay count setting unit 23a. The relay count setting unit 23a stores the relay count data updated by the relay count update unit 21a in the header of the streaming data.

Note that a display device and/or a speaker (not illustrated) may be connected to the node device 20. In such a case, a video is displayed on the display device and audio is output via the speaker based on streaming data written in the stream buffer 22.

The RTT measurement unit 24 measures RTT with respect to a router or a gateway that accommodates the node device 20. In the example illustrated in FIG. 1, the RTT measurement unit 24 measures RTT with respect to the gateway 4. Note that the RTT measurement unit 24 may measure RTT by utilizing for example Ping.

The management packet receiver 25 receives a management packet from the root node device 2 or a different node device. The management packet receiver 25 includes a join request receiver 25a, a join response receiver 25b, and a delivery tree receiver 25c. The join request receiver 25a receives a management packet containing a multicast join request transmitted from a newly-joined node device. However, the join request receiver 25a decides whether or not to accept the received join request in accordance with a result of decision conducted by the response decision unit 27, which will be described later. The join response receiver 25b receives a management packet containing a join response corresponding to the multicast join request. However, after the timer 28 has expired, the join response receiver 25b discards a received management packet containing the join request. Also, when the join response receiver 25b receives a plurality of management packets respectively including join responses, the join response receiver 25b accepts the first management packet and discards subsequent management packets. The delivery tree receiver 25c receives a management packet, containing a delivery tree, transmitted from the root node device 2. Note that the management packet receiver 25 may receive a management packet containing candidate parent node information, a management packet containing a delivery request, and receive other information.

The node specification generator 26 manages node specification information, which is used for deciding whether or not the node device 20 can deliver streaming data. The node specification generator 26 includes a delivery tree state manager 26a and a hardware state manager 26b. The delivery tree state manager 26a manages the state of the delivery tree based on delivery tree information received from the root node device 2. The hardware state manager 26b manages the operation states (loads on the CPU, a free area in a memory) of the hardware resources of the node device 20. The information managed by the delivery tree state manager 26a and the hardware state manager 26b are output as node specification information.

The response decision unit 27 decides whether or not to respond to a multicast join request transmitted from a newly-joined node device based on node specification information generated by the node specification generator 26. The decision by the response decision unit 27 is reported to the join request receiver 25a. An example of the decision by the response decision unit 27 will be explained later.

RTT measured by the RTT measurement unit 24 is set in the timer 28. The timer 28 is activated when the management packet transmitter 29 transmits a management packet containing a multicast join request. When the timer 28 has expired, an expiration report is fed to the join response receiver 25b and a join request generator 29a.

The management packet transmitter 29 transmits a management packet to the root node device 2 and a different node device. The management packet transmitter 29 includes the join request generator 29a, a join response generator 29b, and a delivery request generator 29c. The join request generator 29a transmits a management packet containing a multicast join request illustrated in FIG. 2 to node devices within a specified range. At this time, a multicast address that covers a specified area are provided as a destination address in this management packet. Also, the join request generator 29a adds “TTL=1” to this management packet. However, when receiving an expiration report from the timer 28, the join request generator 29a transmits a management packet containing a unicast join request to the root node device 2. When the join request receiver 25a receives and accepts a join request from a newly-joined node device, the join response generator 29b transmits to the newly-joined node device a management packet containing a join response corresponding to that join request.

The delivery request generator 29c generates a management packet containing a delivery request and transmits the packet to the parent node device. In the example illustrated in FIG. 2 and FIG. 3, the delivery request generator 29c transmits a management packet containing a delivery request to node device 1D, which first returned a join response. In the example illustrated in FIG. 4, the delivery request generator 29c transmits a management packet containing a delivery request to the parent node device determined based on the candidate parent node information. The management packet transmitter 29 may transmit different management packets. For example, the management packet transmitter 29 may transmit a management packet containing the connection information illustrated in FIG. 3 to the root node device 2.

The controller 30 controls the operations of the node device 20. Also, the controller 30 provides other functions related to streaming delivery. For example, the controller 30 may select a parent node device based on candidate parent node information received from the root node device 2.

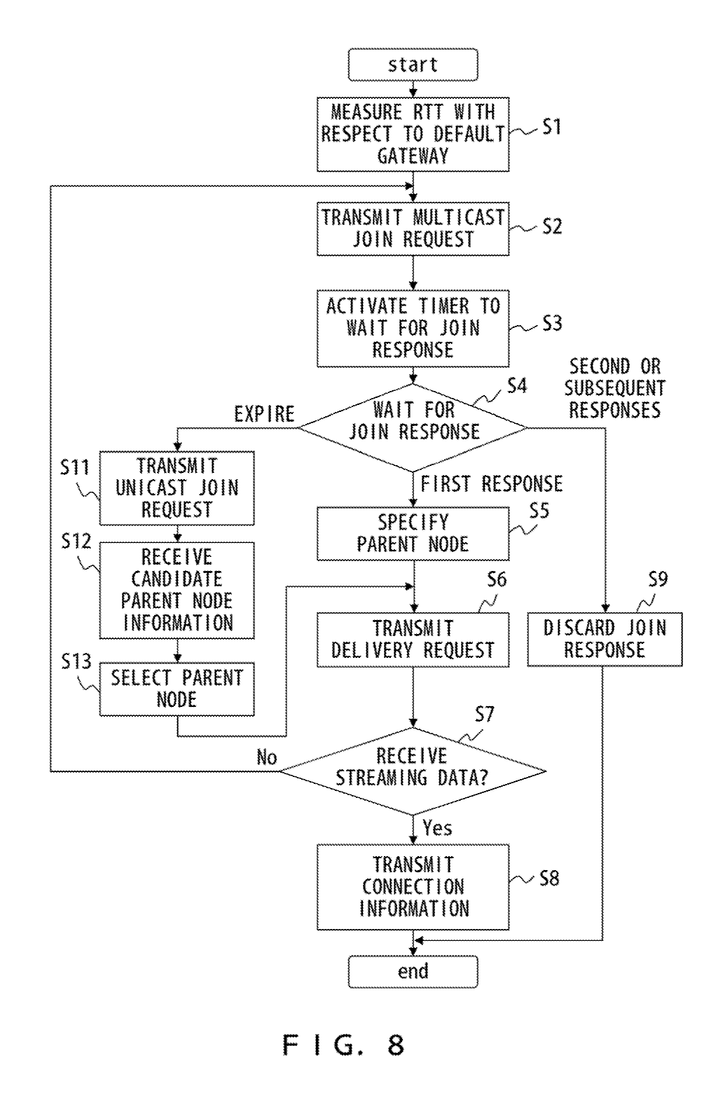

FIG. 8 is a flowchart illustrating operations of a newly-joined node device. The process in this flowchart is executed when for example a user instructs a newly-joined node device to join a streaming service. The process illustrated in FIG. 8 may be realized by executing a program using a computer.

In S1, the RTT measurement unit 24 measures RTT with respect to the default gateway. The default gateway is a router or a gateway that accommodates the newly-joined node device. In S2, the join request generator 29a transmits a multicast join request to node devices within a specified range. In a management packet containing the multicast join request, “TTL=1” is set. Accordingly, this multicast join request is received by node devices within a one-hop range from the newly-joined node device. In S3, the join request generator 29a activates the timer 28 when transmitting the multicast join request. The timer 28 expires when the RTT measured in S1 has passed.

In S4, the join response receiver 25b waits for a join response corresponding to the multicast join request transmitted in S2. If the join response receiver 25b receives a join response before the timer 28 expires, the process of the newly-joined node device proceeds to S5. In S5, the controller 30 specifies a parent node device. In such a case, a source node device of the first join response is specified as a parent node device. In S6, the delivery request generator 29c transmits a delivery request to the parent node device specified in S5. When the join response receiver 25b receives the second or subsequent join responses, the received join responses are discarded in S9.

In S7, the stream receiver 21 confirms whether or not the stream receiver 21 is receiving the streaming data corresponding to the delivery request. When the stream receiver 21 is receiving the streaming data, the management packet transmitter 29 transmits a management packet containing connection information to the root node device 2 in S8. In such a case, connection information includes information for identifying the source node device of the streaming data (i.e., a parent node device). When the stream receiver 21 is not receiving the streaming data corresponding to the delivery request, the process of the node device returns to S2.

If the timer 28 expires before the join response receiver 25b receives a join response, the processes in S11 through S13 are executed. In S11, the join request generator 29a transmits a unicast join request to the root node device 2. In such a case, the root node device 2 returns candidate parent node information to the newly-joined node device in response to that unicast join request. In S12, the management packet receiver 29 receives the candidate parent node information transmitted from the root node device 2. The controller 30 selects a parent node device based on the received candidate parent node information. Thereafter, the process of the newly-joined node device proceeds to S6. In such a case, the delivery request generator 29c transmits a delivery request to the parent node device selected in S13.

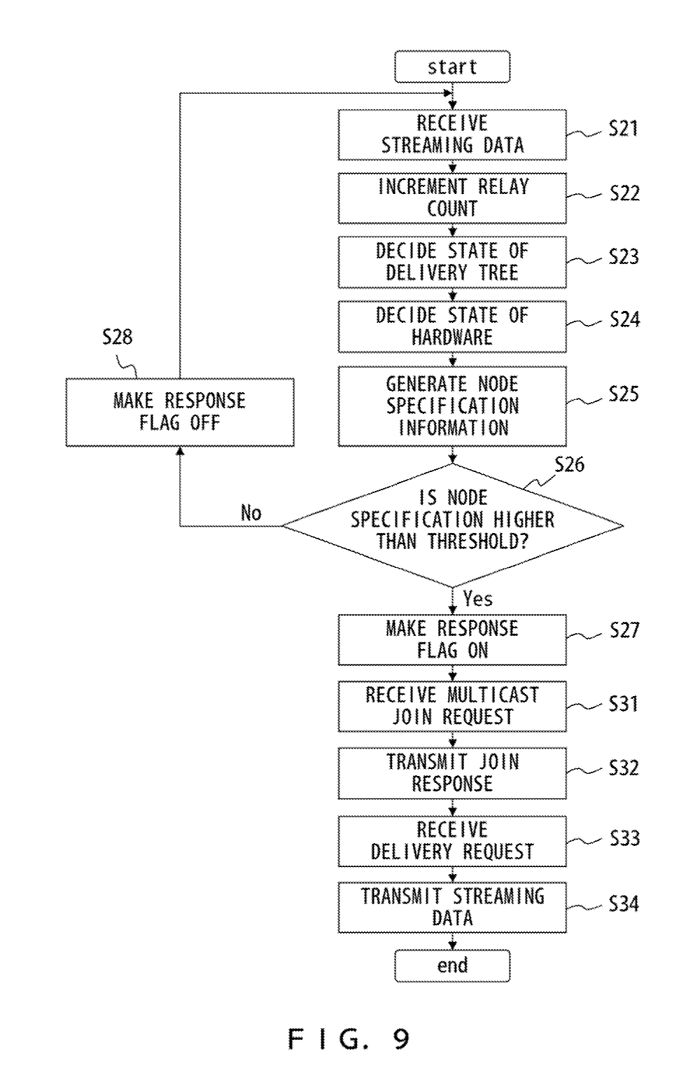

FIG. 9 is a flowchart illustrating operations of a joined node device. The process in this flowchart is executed while a node device is receiving streaming data. The process illustrated in FIG. 9 may be realized by executing a program using a computer.

In S21, the stream receiver 21 receives streaming data. In S22, the relay count update unit 21a increments the relay count data stored in the header of the received streaming data by one. The received streaming data is written in the stream buffer 22.

In S23, the delivery tree receiver 25c receives delivery tree information transmitted from the root node device 2. The delivery tree state manager 26a decides the state of the delivery tree based on the delivery tree information. In S24, the hardware state manager 26b decides the operation states (loads on the CPU, a free area in a memory) of the hardware resources of the node device. In S25, the node specification generator 26 outputs the results of the decisions in S24 and S25 as node specification information.

In S26, based on the node specification information generated by the node specification generator 26, the response decision unit 27 decides whether or not to respond to a multicast join request transmitted from a newly-joined node device. When the response decision unit 27 decides to respond to the join request, the response decision unit 27 makes the response flag ON in S27. A state in which the response flag is ON is a state in which the node device can deliver streaming data. In other words, a state in which the response flag is ON is a state in which the node device can become a parent node device for a different node device. When the response decision unit 27 decides not to respond to the join request, the response decision unit 27 makes the response flag OFF in S28. Note that, when the response flag is in ON state, the join request receiver 25a waits for a multicast join request to be received from a newly-joined node device. When receiving a multicast join request, the join request receiver 25a accepts that join request. When the response flag is in OFF state, the join request receiver 25a discards the join request from a newly-joined node device.

When receiving a multicast join request from a newly-joined node device in S31, the join response generator 29b generates a join response corresponding to that multicast join request in S32. This join response is returned to the source node device of that multicast join request (i.e., a newly-joined node device). This join response is received by the newly-joined node device in S4 in the flowchart illustrated in FIG. 8. Then, the newly-joined node device generates a delivery request in S6.

In S33, the management packet receiver 25 receives the delivery request generated by the newly-joined node device. Then, the stream transmitter 23 transmits the streaming data stored in the stream buffer 22 to the newly-joined node device in S34.

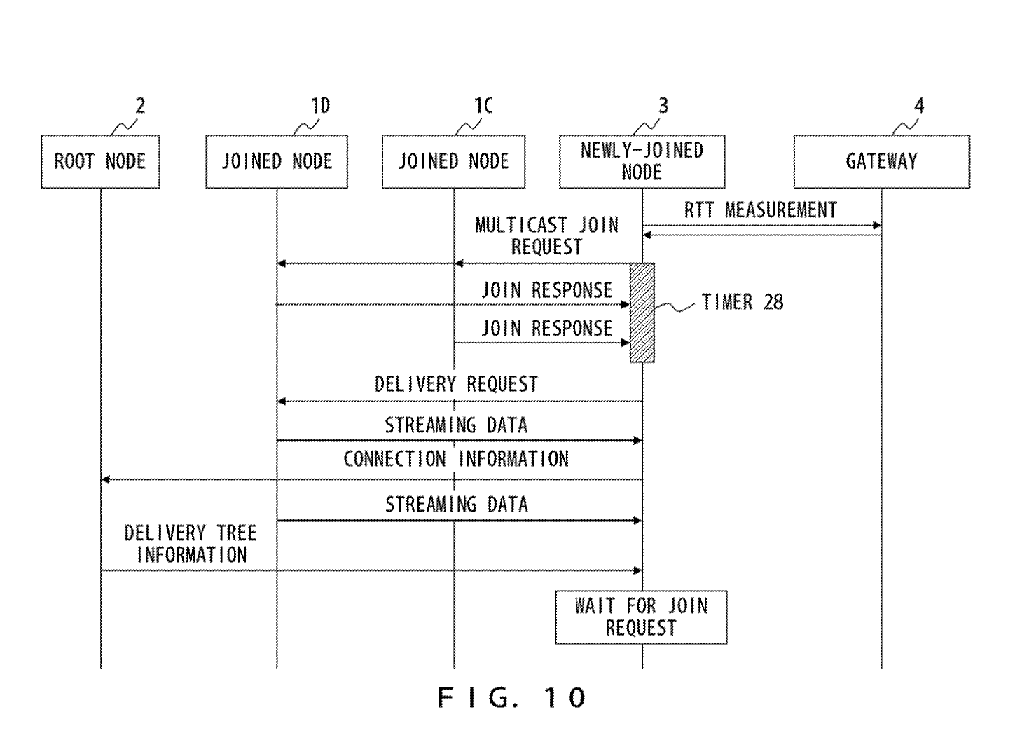

FIG. 10 is a sequence diagram of a video streaming system for a case when a joined node device that can deliver streaming data exists close to a newly-joined node device. This sequence diagram corresponds to the example illustrated in FIGS. 1-3.

The newly-joined node device 3 measures RTT with respect to the gateway 4. Next, the newly-joined node device 3 transmits a multicast join request to node devices belonging to network Y. At this time, the timer 28 is activated. This multicast join request is received by joined node devices 1C and 1D. It is assumed in this example that joined node devices 1C and 1D are set in a state in which they respectively respond to join requests. Thus, joined node devices 1C and 1D respectively return join responses to the newly-joined node device 3.

The newly-joined node device 3 receives join responses respectively returned from joined node devices 1C and 1D before the expiration of the timer 28. In this example, the newly-joined node device 3 first receives the join response returned from joined node device 1D and then receives the join response returned from joined node device 1C. In such a case, the newly-joined node device 3 decides that joined node device 1D is the joined node device that exists closest to the newly-joined node device 3 among node devices that can deliver streaming data. By so doing, the newly-joined node device 3 transmits a delivery request to joined node device 1D. Also, joined node device 1D starts delivering streaming data to the newly-joined node device 3. Further, the newly-joined node device 3 transmits to the root node device 2 connection information indicating that joined node device 1D is the parent node device of the newly-joined node device 3. The root node device 2 updates the delivery tree information in accordance with this connection information.

Thereafter, the root node device 2 transmits the updated delivery tree information to the respective joined node devices (including the newly-joined node device 3). The newly-joined node device 3 decides whether or not to respond to a join request based on the delivery tree information and the operation states of the hardware resources of the newly-joined node device 3. When the newly-joined node device 3 decides to respond to a join request, the newly-joined node device 3 waits for a multicast join request transmitted from a different node device.

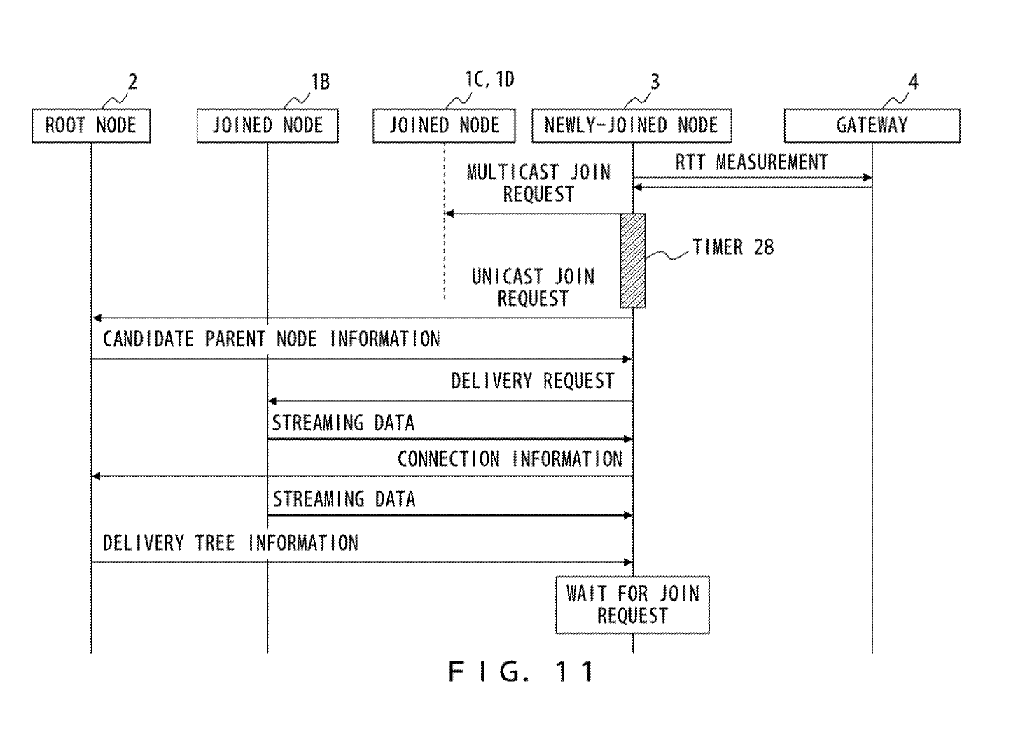

FIG. 11 is sequence diagram of a video streaming system for a case when no joined node devices that can deliver streaming data exist close to a newly-joined node device. This sequence diagram corresponds to the example illustrated in FIG. 1, FIG. 2, and FIG. 4.

The operations of measuring RTT and of transmitting a multicast join request are similar between FIG. 10 and FIG. 11. However, in the example illustrated in FIG. 11, the newly-joined node device 3 does not receive a join response before the expiration of the timer 28. In such a case, the newly-joined node device 3 transmits a unicast join request to the root node device 2. Then, the root node device 2 generates candidate parent node information and returns the information to the newly-joined node device 3.

The newly-joined node device 3 selects a parent node device based on the candidate parent node information received from the root node device 2. In this example, joined node device 1B is selected as the parent node device. Thus, the newly-joined node device 3 transmits a delivery request to joined node device 1B. Then, joined node device 1B starts delivering streaming data to the newly-joined node device 3. The operations subsequent to this are substantially similar to each other between FIG. 10 and FIG. 11, and the explanations thereof will be omitted accordingly.

Next, explanations will be given for a method in which a joined node device decides whether or not to respond to a multicast join request. This decision is conducted by the response decision unit 27 as described above.

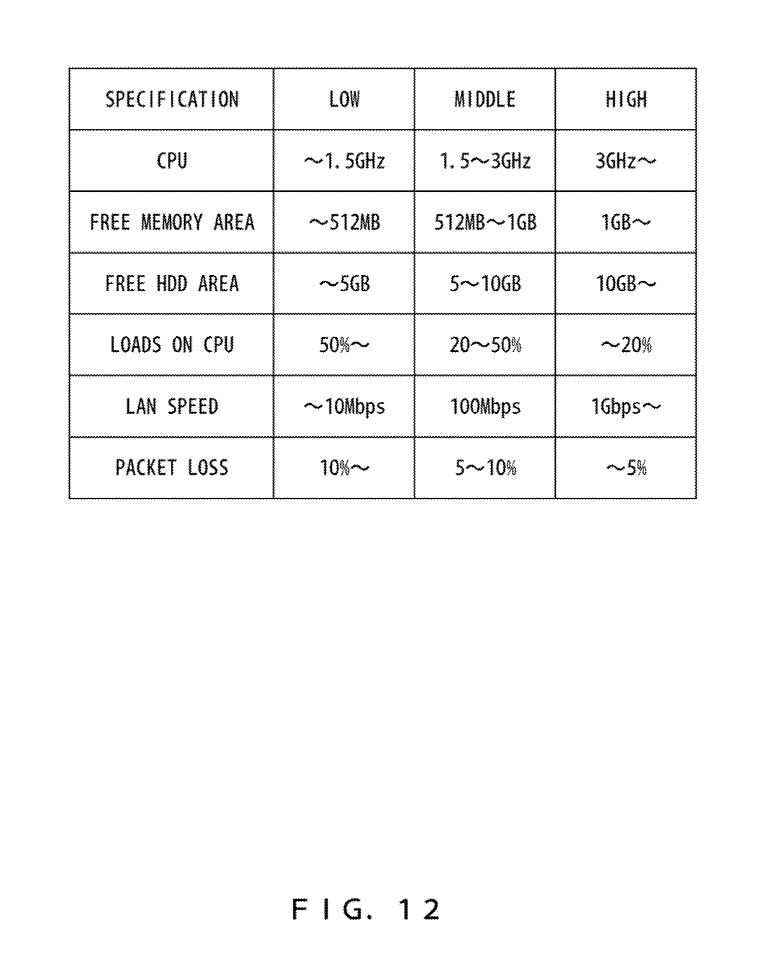

In the example illustrated in FIG. 12, the decision is conducted based on the specifications of a node device. The specifications of a node device represent the performance of the hardware and the operation states of the node device. In this example, the following six factors are taken into consideration. It is assumed that factors (2), (3), (4) and (6) are detected for example periodically.

### (1) Performance of CPU

(2) Free area in memory
(3) Free area in HDD
(4) Loads on CPU (usage rate)
(5) Communication speed of LAN interface
(6) Packet loss ratio

When at least one of the above six factors is decided to be “low”, the response decision unit 27 makes the response flag OFF. When there are no factors that are decided to be “low”, the response decision unit 27 makes the response flag ON. This method makes it more likely that a newly-joined node device will be connected to a node device having a larger available capacity in the hardware resources.

The response decision unit 27 may conduct the above decision in accordance with the delivery states of the node device of the response decision unit 27. For example, when the number of child nodes (i.e., the number of delivery destination nodes) has reached a threshold (three for example), the response decision unit 27 makes the response flag OFF. This method makes it more likely that a newly-joined node device will be connected to a node device having fewer child nodes.

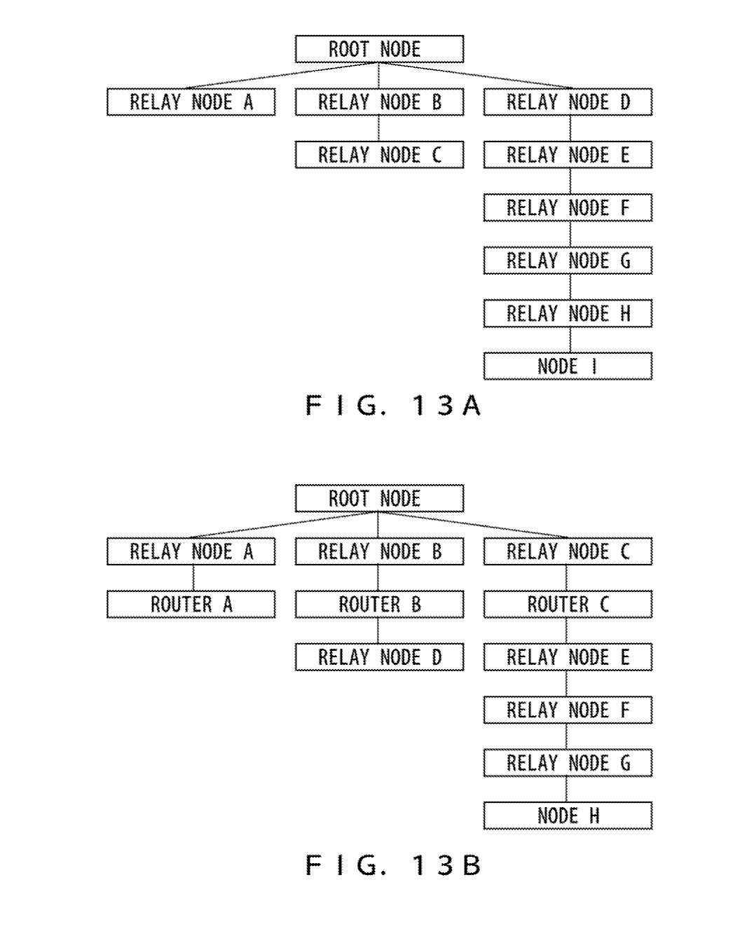

Further, the response decision unit 27 may conduct the above decision based on delivery tree information received from the root node device. It is assumed as an example that delivery tree information representing the delivery tree illustrated in FIG. 13A is transmitted from the root node device to each joined node device. The response decision unit 27 of each node device makes the response flag OFF when the difference between the number of relays in the route between the root device and the node device of the response decision unit 27 and the minimum number of relays in the delivery tree has reached a threshold (five for example). The minimum number of relays represents a minimum value among the numbers of relays between the root node device and the most downstream nodes in the respective delivery routes. In the example illustrated in FIG. 13A, the minimum number of relays is “1”, which is detected for relay node A. The number of relays detected for node I is “6”. In such a case, since the difference is “5”, the response decision unit 27 of node I makes the response flag OFF. This method makes it more likely that a newly-joined node device will be connected to a node device in a short delivery route.

The response decision unit 27 may conduct, based on the delivery tree information, the decision described above for each network that is located under a router. It is assumed for example that delivery tree information representing the delivery tree illustrated in FIG. 13B is transmitted from the root node device to each joined node device. The response decision unit 27 of each node device makes the response flag OFF when the number of upstream nodes in a local network to which the node device belongs reaches a threshold (three for example) and an upstream node device in the local network can accept a child node. In the delivery tree illustrated in FIG. 13B, nodes E, F, G and H belong to the same network. In this situation, three relay nodes are located on the upstream side of node H. Further, when at least one of nodes E, F and G is registered in the candidate parent node information, the response decision unit 27 of node H makes the response flag OFF. This method makes it more likely that a newly-joined node device will be connected to an upstream node device, leading to more stable delivery operations.

### Other Examples

In the above example, RTT between the newly-joined node device 3 and the gateway 4 is measured by using a timer so as to search for a joined node device as a parent node device that exists closer to the newly-joined node device 3 than does the gateway 4. However, the present invention is not limited to this method. The timer 28 may measure a certain period of time that is specified beforehand. This method also makes it possible for the newly-joined node device 3 to receive streaming data from a joined node device located close to the newly-joined node device 3 by appropriately specifying the certain period of time.

Also, a newly-joined node device does not have to use a timer when searching for a parent node device. For example, after transmitting a multicast join request, a newly-joined node device may decide the joined node device that first returned a join response as a parent node device.

Further, “TTL=1” is added to a multicast join request in the above example. However, the present invention is not limited to this method. In other words, it is not necessary to set the TTL in a multicast join request. When the TTL is not set in a multicast join request, a newly-joined node device may receive a join response from a joined node device that is located two or more hops away from the newly-joined node device. However, when a newly-joined node device receives a plurality of join responses, the newly-joined node device decides a parent node device based on the join response received first. Accordingly, there is a low possibility that a joined node device at a location that is two or more hops away from a newly-joined node device will be selected as a parent node.

<Hardware Configuration of Node Device>

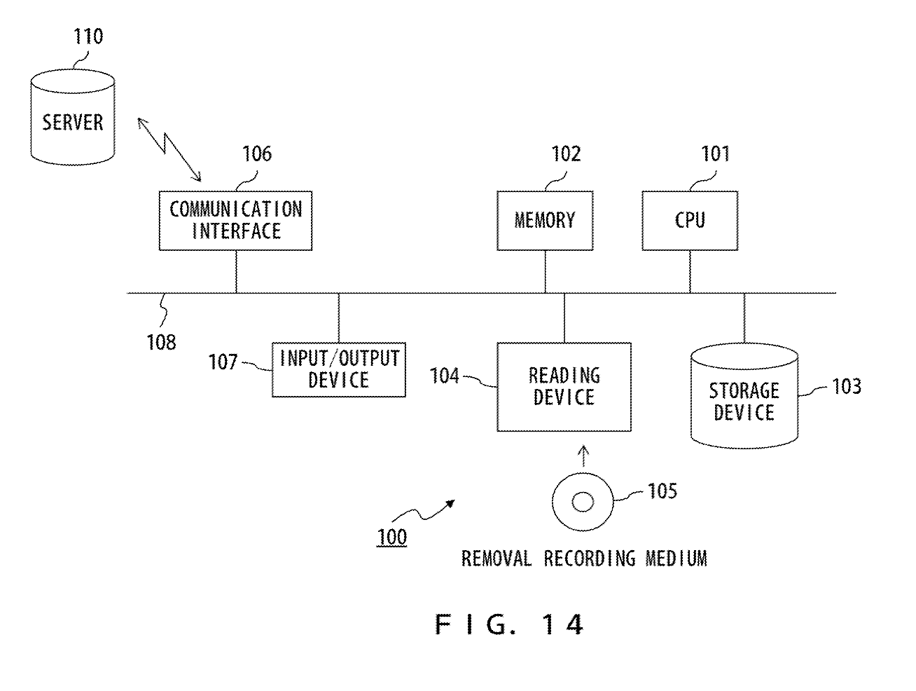

FIG. 14 illustrates an example of a hardware configuration of a node device (a root node device, a joined node device, or a newly-joined node device) according to the embodiment of the present invention. A node device includes a computer system 100 illustrated in FIG. 14. The computer system 100 includes a CPU 101, a memory 102, a storage device 103, a reading device 104, a communication interface 106, and an input/output device 107. The CPU 101, the memory 102, the storage device 103, the reading device 104, the communication interface 106, and the input/output device 107 are connected with each other via for example a bus 108.

The CPU 101 executes a delivery control program that describes the process of the flowchart illustrated in FIG. 8 or FIG. 9 by using the memory 102. Thereby, the video streaming methods described above are realized. The memory 102 is for example a semiconductor memory, and includes a RAM area and a ROM area. The storage device 103 is for example a hard disk device, and stores the delivery control program described above. Also, the storage device 103 may store streaming data. Note that the storage device 103 may be a semiconductor memory such as a flash memory, etc. Also, the storage device 103 may be an external recording device.

The reading device 104 accesses a removal recording medium 105 in accordance with an instruction from the CPU 101. The removal recording medium 105 is implemented by for example a semiconductor device (a USB memory or the like), a medium that information is input into and output from by the use of magnetic effects (a magnetic disk or the like), a medium that information is input into and output from by the use of optical effects (a CD-ROM, a DVD or the like), etc. The communication interface 106 can transmit and receive data via a network in accordance with an instruction from the CPU 101. The input/output device 107 includes a device that receives instructions from users, a device that outputs streaming data, and other devices.

The delivery control program according to the embodiments is provided to the computer system 100 in for example the following forms.

(1) Installed in the storage device 103
(2) Provided from the removal recording medium 105
(3) Provided from a program server 110

As described above, according to the embodiments of the invention, a period of waiting time for a newly-joined node device to receive streaming data in a video streaming system that performs streaming delivery based on P2P is reduced.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present inventions have been described in detail, it should be understood that the various changes, substitutions, and alterations could be made hereto without departing from the spirit and scope of the invention.

What is claimed is:

1. A streaming system that provides a streaming service to a node device, the streaming system comprising:
a newly-joined node device configured to newly join the streaming service and transmit a join request to a node device within a specified range; and
a node device configured to receive the join request and return a join response corresponding to the join request to the newly-joined node device when the node device that receives the join request is capable of providing the streaming service, wherein
the newly-joined node device transmits a delivery request to a node device that first returns the join response corresponding to the join request.

2. The streaming system according to claim 1, wherein
the newly-joined node device transmits the join request to a node device within a range in which TTL (Time To Live) is one.

3. The streaming system according to claim 1, wherein
the newly-joined node device transmits a join request to a root node device that manages a delivery state of the streaming service when the newly-joined node device does not receive the join response within a specified period of time since the newly-joined node device transmits the join request,
the root node device returns, to the newly-joined node device, candidate node information representing a node device that provides the streaming service, and
the newly-joined node device selects a parent node device based on the candidate node information, and transmits a delivery request to the selected parent node device.

4. The streaming system according to claim 3, wherein
the specified period of time is a round trip time between the newly-joined node device and a router or a gateway that accommodates the newly-joined node device.

5. The streaming system according to claim 1, wherein
a node device that receives streaming data of the streaming service decides whether or not to accept the join request based on an operation state of the node device that receives the streaming data of the streaming service.

6. The streaming system according to claim 1, wherein
the node device that receives streaming data of the streaming service decides whether or not to accept the join request based on a state of a delivery tree that represents a route in which the streaming data flows.

7. A node device used in a streaming system that provides a streaming service, the node device comprising a processor, wherein
the processor executes a streaming data request process, and the process comprises:
transmitting a join request to another node device within a specified range;
receiving a join response corresponding to the join request from the other node device that receives the join request and that is capable of providing the streaming service; and
transmitting a delivery request to the other node device that first returns the join response corresponding to the join request.

8. A streaming data delivery method that provides a streaming service to a node device, the method comprising:
transmitting a join request, by a newly-joined node device which newly joins the streaming service, to a node device within a specified range;
transmitting a join response corresponding to the join request, by a node device that receives the join request, to the newly-joined node device when the node device that receives the join request is capable of providing the streaming service; and
transmitting a delivery request, by the newly-joined node device, to a node device that first returns the join response corresponding to the join request.

9. A non-transitory computer-readable recording medium having stored therein a program for causing a computer in a node device to execute a streaming data request process, the process comprising:
transmitting a join request to another node device within a specified range;
receiving a join response corresponding to the join request from the other node device that receives the join request and that is capable of providing the streaming service; and
transmitting a delivery request to the other node device that first returns the join response corresponding to the join request.
